(19) United States
(12) Patent Application Publication
(10) Pub. No.: US 2010/0044995 A1
(43) Pub. Date: Feb. 25, 2010

(54) QUICK BOARD WITH HANDLE TO OPERATE DRIVING POWER OF FRONT WHEEL

(76) Inventor: Bong Hwan PARK, INCHEON (KR)

Correspondence Address: IPLA P.A., 3550 WILSHIRE BLVD., 17TH FLOOR, LOS ANGELES, CA, 90010, US

(21) Appl. No.: 12/337,418

(22) Filed: Dec. 17, 2008

(30) Foreign Application Priority Data
Aug. 20, 2008 (KR) 10-2008-0081379
Sep. 12, 2008 (KR) 10-2008-0090401

(51) Int. Cl. B62M 1/16

(52) U.S. Cl. 280/246

(57) ABSTRACT

A quick board with a handle to operate the driving power of a front wheel is used for leisure, taste and amusement activities of teenagers, adults, children and others. In the quick board according to the present invention, the driving power to drive a front wheel is operated by only a handle of the quick board, thereby strengthening the muscular strength of the arms and waist of a user and minimizing the components of the quick board to avoid the complicated configuration in appearance. When a child who has a difficulty in pivoting a driving frame forward and backward operatively connected to a handle part to drive the front wheel uses a quick board, a front wheel cover part of a main body frame and the driving frame are selectively fixed so that such a user can enjoy the quick board in a stable and safe state.

### CROSS REFERENCES

This application claims foreign priority under Paris Convention and 35 U.S.C. § 119 to Korean Patent Application Nos. 10-2008-0081379 filed Aug. 20, 2008, and 10-2008-0090401 filed Sep. 12, 2008, each with the Korean Intellectual Property Office.

### BACKGROUND OF THE INVENTION

1. Field of the Invention

The present invention relates to a quick board and, more particularly, to a quick board in which a driving power of a front wheel to transfer a motive power to the quick board is operated by a handle, that is, the driving power to drive the front wheel of the quick board is operated by only the handle of the quick board, thereby strengthening the muscular strength of the arms and waist of a user.

2. Discussion of Related Art

A game device or a sports device called a quick board comprises: its opposite ends being each streamlined, its middle with a foothold where the feet of a user is received, and the front and rear wheels each having a small diameter positioned in the front and rear of the foothold slid on the ground, using the feet.

Recently, it is well-known that a quick board has the form in which the length of a foothold is elongated, a front wheel is enclosed toward its front end, a connected and extended handle is installed, and a brake unit is included in the handle.

This kind of a quick board is slid forward when a user pushes off the ground by using one foot while placing the other foot on the foothold. During the quick board moves forward, the quick board can travel within a given distance after the user placed both feet on the foothold. However, since a speed rapidly decreases, a traveling speed is not constant, and a driving power obtained by pushing the ground using the foot is weak, a traveling distance is considerably shortened and it is difficult to get a continuous speed.

Moreover, since it is impossible to travel on the surface of an uphill road, a problem of carrying a quick board cannot be solved.

To solve the aforementioned problems, various structures for a quick board have been suggested. For example, Korean Patent Application No. 2002-37275 and the like disclose a number of a bicycle combined with a quick board and the like.

The technical contents of a number of the patents earlier filed or registered are mainly related to a quick board used by applying the saddle and pedal structures of a bicycle, in which a user sits down on the saddle and moves forward by using the pedals in the uphill road and the like. However, since the structure is complicated and is similar to that of a bicycle having small wheels, the size of the product becomes relatively bigger.

To obtain a rotation ratio enabling an enjoyable speed in a wheel having a small diameter by using pedals, the structure cannot avoid forming the complex appearance of multi-level gears or increasing the diameter of a sprocket connected to a pedal and so on, and a chain may be separated away as in a bicycle during operation.

Moreover, since a user operates a conventional bicycle combined with a quick board using only the feet while sitting down on the saddle, the effect of a whole body exercise decreases.

To solve the aforementioned problems, Korean Patent Registration No. 642140 owned by the present applicant disclosed a “quick board capable of operating the rotation of front and rear wheels”. However, since the prior art needs an additional gear box to drive the rear wheel, pedals and the like, it has the complicated structure.

Moreover, when moving forward the front wheel by pivoting the handle forward or backward, a beginner or specially, a child is likely to press the handle forward, thereby having a possibility to cause an accident.

Therefore, a power transmission structure needs the powerful power transmission capable of driving the front wheel in a gentler manner, without a strong force.

### SUMMARY OF THE INVENTION

Therefore, the present invention is directed to provide a quick board which is simple and stable without any complicated structure and which is operated with more safety by overcoming the aforementioned problems of the prior art and improving the prior art.

Another object of the present invention is to provide a quick board which is capable of performing powerful power transmission in a gentle manner without any strong action when the power is transmitted by the forward or backward pivot motion of a driving frame operated by a user.

In accordance with an exemplary embodiment, the present invention provides a quick board with a handle to operate a driving power of a front wheel which includes a handle part 110, a board 140, and front and rear wheels 120 and 130, comprising: a main body frame 150 supportedly connected to opposite sides of the rear wheel 130 by a second branch frame 153 divided in a front side of the rear wheel 130; a driving frame 170 including a ratchet gear part 160 having a one-way clutch bearing 161 coupled with gear-wheels 121a positioned at opposite ends of a spline shaft 121 of the front wheel 120, and a planet gear part 180 in contact with a side of the ratchet gear part 160 to rotate the ratchet gear part 160 and the planet gear part 180; and a board 140, and wherein the driving frame 170 spaced apart on opposite sides of the front wheel 120 is operatively connected to the handle part 110 and the outer circumferential surface of the ratchet gear part 160.

In accordance with another exemplary embodiment, the present invention provides a quick board with a handle to operate a driving power of a front wheel which includes front and rear wheels 120 and 130 positioned in front and rear of a main body frame 150, a board 140 stably and fixedly received on a top surface of the main body frame 150, and a handle part 110, comprising: a main body frame 150 supportedly connected to opposite sides of the rear wheel 130 by a second branch frame 153 divided in a front side of the rear wheel 130; a driving frame 170 including a ratchet gear part 160 having a one-way clutch bearing 161 coupled with gear-wheels 121a positioned at opposite ends of a spline shaft 121 of the front wheel 120 and wherein the driving frame 170 spaced apart on opposite sides of the front wheel 120 is operatively connected to the handle part 110 and the outer circumferential surface of the ratchet gear part 160 to rotate the ratchet gear part 160; and each of gear-wheels 191 positioned at the left and right sides of a bracket 190 fixed to a side of a first branch frame 152 and connected to a guide chain 192, a guide frame 174 extended downward at a lower end side of the driving frame 170, a driving gear 200 coupled to the guide chain 192 by the gear-wheels, a first coaxial gear 210 which is connected to the driving gear 200 by a shaft (a first shaft S1) and connected to a first driven gear 220 by a chain 250, and a second coaxial gear 230 which is connected to a second driven gear 240 by a chain 250′ and connected to the first driven gear 220 by another shaft (a second shaft S2) so as to be rotated in the guide frame 174, wherein the second driven gear 240 is operatively connected to the spline shaft 121 so that when the handle part 110 is pivoted, the rotation power of the driving gear 200 rotates the second driven gear 240, to drive the front wheel 120 through the spline shaft 121.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a perspective view illustrating a quick board according to a first exemplary embodiment of the present invention;

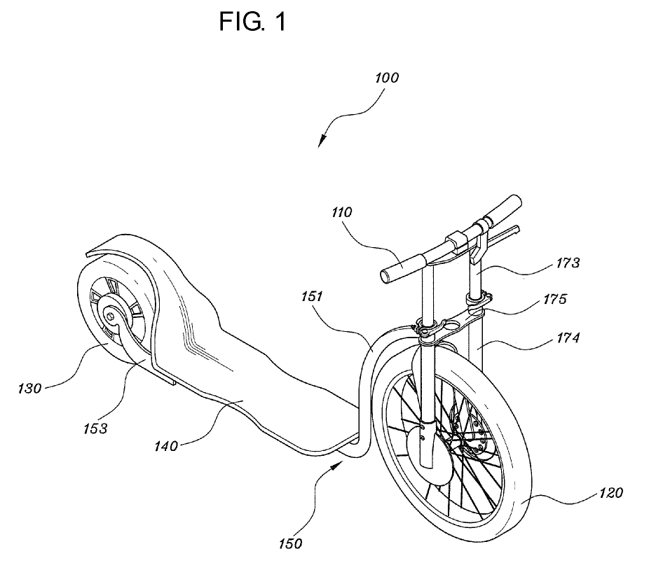

FIG. 2 is a separate perspective view illustrating the quick board of FIG. 1;

FIG. 3 is a separate view illustrating a ratchet gear part applied to a front wheel of the quick board of FIG. 1;

FIG. 4 is a side view illustrating the quick board of FIG. 1, in which a driving frame operatively connected to a handle part is pivoted in the same direction by pivoting the handle part, to provide a forward driving power to the front wheel;

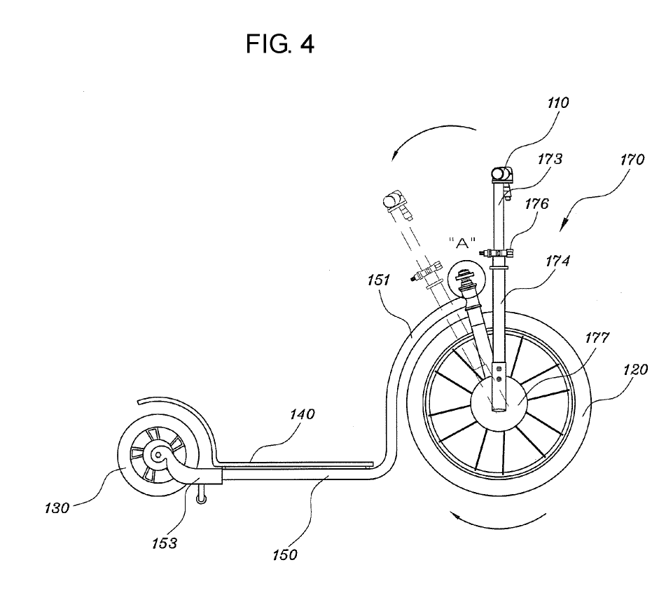

FIG. 5 is a partial enlarged rear view illustrating the front wheel of the quick board of FIG. 1;

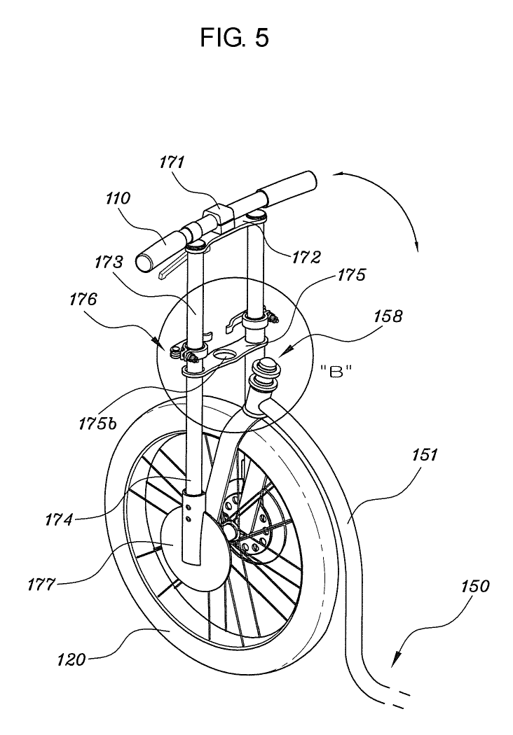

FIG. 6 is a separate enlarged perspective view of part “A” in FIG. 4, illustrating a driving frame fixing part to selectively connect and fix a driving frame and a main body frame of the quick board of FIG. 1;

FIG. 7 is a partial enlarged perspective view of part “B” in FIG. 5, illustrating that the driving frame and the main body frame are fixed by the driving frame fixing part of FIG. 6 at a user's selection;

FIG. 8 is a perspective view of a quick board according to a second exemplary embodiment of the present invention;

FIG. 9 is a separate perspective view illustrating the quick board of FIG. 8;

FIG. 10 is a separate view illustrating a ratchet gear part applied to a front wheel of the quick board of FIG. 8;

FIG. 11 is a side view illustrating the quick board of FIG. 8, in which a driving frame operatively connected to a handle part is pivoted in the same direction by pivoting the handle part, to provide a forward driving power to the front wheel;

FIG. 12 is a separate perspective view illustrating a power transmission unit to obtain the forward driving power of the quick board of FIG. 8; and

FIG. 13 is a separate perspective view illustrating another power transmission unit according to a modified example, to obtain a forward driving power of the quick board of FIG. 8.

[Brief description of main reference numbers in drawings]

| | |
|---|---|
| 100: quick board | 110: handle part |
| 120: front wheel | 121: spline shaft |
| 121a: gear-wheel | 130: rear wheel |
| 140: board | 150: main body frame |
| 151: front wheel cover part | 152: first branch frame |
| 153: second branch frame | 154: cylindrical member |
| 154a: coupling element | 155: bearing |
| 156: cover body | 157: fixing element |
| 157a: protruding element | 158: driving frame fixing part |
| 160: ratchet gear part | 161: one-way clutch bearing |
| 162: connection flange | 163: cover |
| 170: driving frame | 171: center frame body |
| 172: upper connection bar | 172a: coupling opening |
| 173: up/down lift frame | 174: guide frame |
| 175: lower connection bar | 175a: coupling openings |
| 176: position fixing element | 177: side cover body |
| 190: bracket | 191: gear-wheel |
| 192: guide chain | 200: driving gear |
| 210: first coaxial gear | 220: first driven gear |
| 230: second coaxial gear | 240: second driven gear |
| 250, 250: chain | S1: first shaft |
| S2: second shaft | B: bearing |

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these exemplary embodiments are provided as teaching examples of the invention. Like numbers refer to like element.

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. The best modes of the present invention will be described with reference to first and second exemplary embodiments.

In accordance with a first exemplary embodiment of the present invention, a quick board 100 with a handle to operate a driving power of a front wheel which includes a handle part 110, a board 140 and front and rear wheels 120 and 130, comprises:

a main body frame 150 supportedly connected to opposite sides of the front wheel 120 by a first branch frame 152 divided from an upper end of a front wheel cover part 151 in a rod shape which covers from rear to top of the front wheel 120, horizontally extended straight from a lower end of the front wheel cover part 151, and the main body frame 150 supportedly connected to opposite sides of the rear wheel 130 by a second branch frame 153 divided from a front of the rear wheel 130;

a driving frame 170 including a ratchet gear part 160 and a planet gear part 180 in either one side of the front wheel 120 to forward drive the front wheel 120 in one direction, wherein the ratchet gear part 160 includes a one-way clutch bearing 161 connected to gear-wheels 121a at opposite ends of a spline shaft 121 of the front wheel 120 and the planet gear part 180 is provided to contact with a side of the ratchet gear part 160, and the driving frame 170 spaced apart on opposite sides of the front wheel 120 and operatively connected to the handle part 110 and the outer circumferential surface of the ratchet gear part 160 to rotate the ratchet gear part 160 and the planet gear part 180; and

a board 140 stably received and connected to a top side of the main body frame 150.

In accordance with a second exemplary embodiment of the present invention, a quick board 100 with a handle to operate a driving power of a front wheel, which includes front and rear wheels 120 and 130 each positioned in front and rear of a main body frame 150, a board 140 stably received and fixed onto a top of the main body frame 150 and a handle part 110, comprises:

a main body frame 150 supportedly connected to opposite sides of the front wheel 120 by a first branch frame 152 divided from an upper end of a front wheel cover part 151 in a rod shape which covers from rear to top of the front wheel 120, horizontally extended straight from a lower end of the front wheel cover part 151, and the main body frame 150 supportedly connected to opposite sides of the rear wheel 130 by a second branch frame 153 divided from a front side of the rear wheel 130;

a driving frame 170 including a ratchet gear part 160 in either one side of the front wheel 120 to forward drive the front wheel 120 in one direction, wherein the ratchet gear part 160 includes the one-way clutch bearing 161 connected to gear-wheels 121a at opposite ends of a spline shaft 121 of the front wheel 120, and the driving frame 170 spaced apart on the opposite sides of the front wheel 120 to rotate the ratchet gear part 160 and operatively connected to the handle part 110 and the outer circumferential surface of the ratchet gear part 160 to rotate the ratchet gear part 160; and

a bracket 190 fixed on a side surface of the first branch frame 152, gear-wheels 191 each positioned at left and right sides of the bracket 190, a guide chain 192 connecting the gear-wheels 191, a guide frame 174 extended downward at a lower end side of the driving frame 170, a driving gear 200 coupled to the guide chain 192 by the gear-wheels, a first coaxial gear 210 which is connected to the driving gear 200 by a shaft (a first shaft S1) and connected to a first driven gear 220 by a chain 250, and a second coaxial gear 230 which is connected to a second driven gear 240 by a chain 250′ and connected to the first driven gear 220 by another shaft (a second shaft S2) so as to be rotated in the guide frame 174, wherein the second driven gear 240 is operatively connected to the spline shaft 121 so that when the handle part 110 is pivoted, the rotation power of the driving gear 200 rotates the second driven gear 240, to drive the front wheel 120 through the spline shaft 121.

The present invention has the structure to transmit the driving power to the front wheel of the quick board by using the handle part. The present invention may be carried out by pivoting the handle forward and backward operatively in connection with the front wheel in a structure of using the planet gear part connected to the front wheel and another structure of using the chain unit without any planet gear part.

The structure of the quick board in which the front wheel is driven by the planet gear part according to the first exemplary embodiment of the present invention and the structure of the quick board in which the front wheel is driven by the chain unit according to the second exemplary embodiment of the present invention will be described in detail below.

### FIRST EXEMPLARY EMBODIMENT

In accordance with the first embodiment of the present invention, as illustrated in the attached drawings, front and rear wheels 120 and 130 are connected to each other by a main body frame 150, and a driving frame 170 connected to a handle part 110 is connected to opposite sides of the front wheel 120. A ratchet gear part 160 and a planet gear part 180 are connected to either one side of the front wheel 120, wherein the ratchet gear part 160 is to drive the front wheel 120 forward and the planet gear part 180 is in contact with the side of the ratchet gear part 160. When a user pivots the handle part 110 forward or backward, the driving frame 170 operatively connected to the handle part 110 rotates the ratchet gear part 160 and the planet gear part 180 so that the quick board 100 is moved forward as the front wheel 120 is driven forward.

The present invention in the aforementioned structure comprises: the main body frame 150, the front wheel 120 and rear wheel 130 respectively connected to front and rear parts of the main body frame 150 so as to be driven, the board 140 stably received and fixed to the main body frame 150, the driving frame 170 to drive the front wheel 120, and the handle part 110 to pivot the driving frame 170 forward or backward.

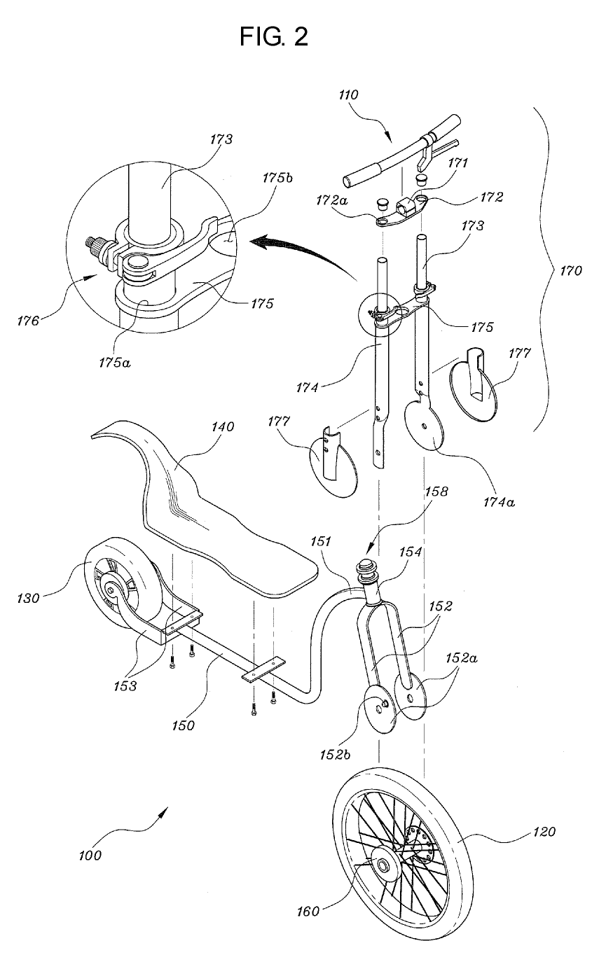

As illustrated in FIG. 2, the main body frame 150 comprises: a front wheel cover part 151 formed upward from a rear side of the front wheel 120 in a uniform curvature, a first branch frame 152 connected from a front end of the front wheel cover part 151 to each of the opposite sides of the front wheel 120, and a second branch frame 153 connected to the rear wheel 130 horizontally extended from a rear side of the first branch frame 152.

The first branch frame 152 is configured irrelevantly to the driving of the front wheel 120. The first branch frame 152 has a disk-type plate 152a at its end opposite surfaces. The ratchet gear part 160 and the planet gear part 180 contacting with the ratchet gear part 160 operatively rotated of the present invention are positioned at either inner side of the disk-type plate 152a. A stopper 152b is positioned at either outer side of the disk-type plate 152a, preferably to prevent the driving frame 170 from being excessively pivoted toward a front side of the front wheel 120.

The second branch frame 153 horizontally extended from a rear side of the first branch frame 152 is formed to support and connect the rear wheel 130 at a rear side of the main body frame 150.

Accordingly, the front wheel 120 and the rear wheel 130 are supported and fixedly connected to each other by the first and second branch frames 152 and 153 extended to the front and rear sides from the main body frame 150.

As illustrated, to provide the quick board 100 according to the present invention, the diameter of the front wheel 120 is to be relatively greater than that of the rear wheel 130.

The reason why the diameter of the front wheel 120 needs to be greater than that of the rear wheel 130 is to properly obtain the forward movement power of the quick board 100 when the handle part 110 is pivoted forward or backward.

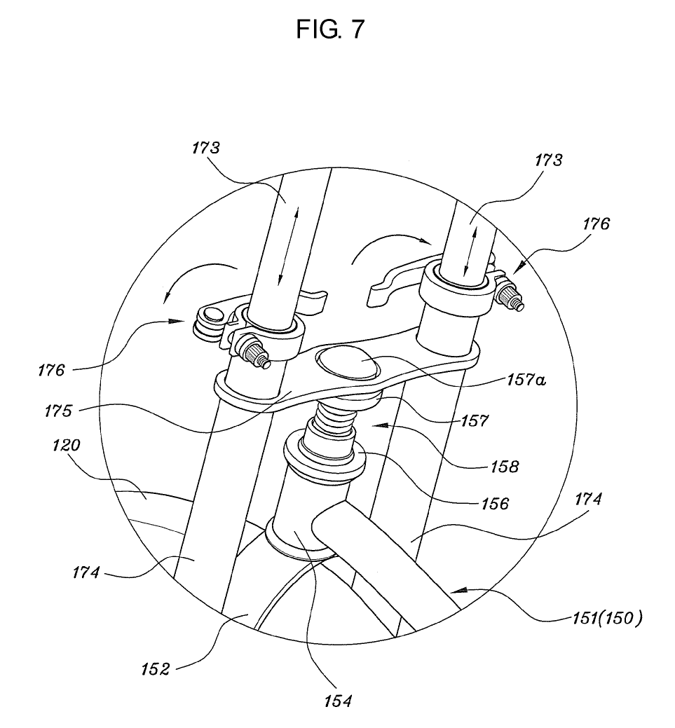

As illustrated in FIG. 7, when it needs to control the forward or backward pivot motions of the driving frame 170 to be described later, for example, when a child, an unskilled person or the like uses the quick board 100 according to the present invention and pivots the handle part 100 and the driving frame 170 forward or backward, such a user is likely to lose balance and to fall forward, causing an accident.

In order for a child, an unskilled person or the like to stably and safely use the quick board 100, it is preferably to use the driving frame 170 fixed to the main body frame 150.

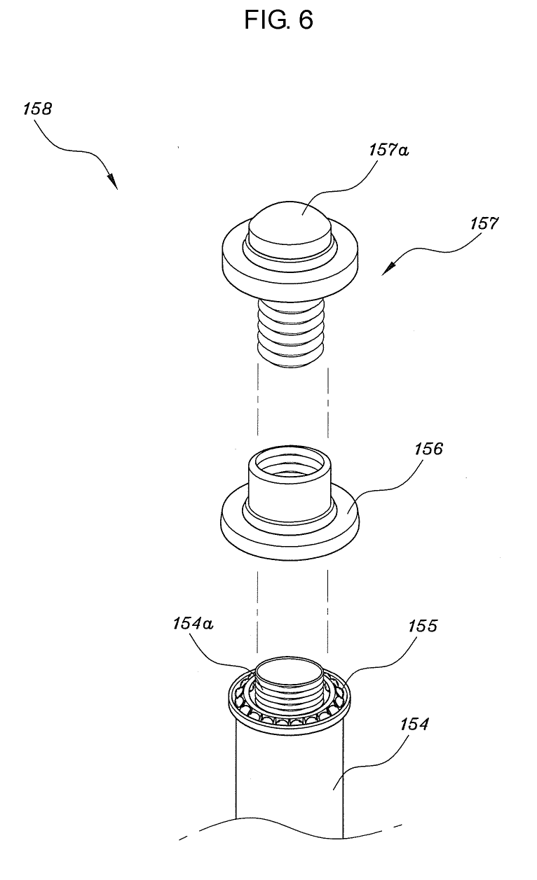

To this end, a bearing 155 is inserted into the inner circumferential surface side at a top part of a cylindrical member 154. The cylindrical member 154 is positioned at a contact point where an upper end of the front wheel cover part 151 of the main body frame 150 contacts with the first branch frame 152 extended downward from the upper end of the front wheel cover part 151 (shown in FIG. 6). A coupling element 154a is formed to protrude from the bearing 155 inserted inner circumferential surface integrally with the cylindrical member 154. The coupling element 154a is formed in a screw shape on the outer circumferential surface. A cover body 156 is hollow to be screw-coupled with the coupling element 154a. The cover body 156 has the inner circumferential surface forming a female screw. A fixing element 157 is formed to be screw-coupled to the female screw formed on the inner circumferential surface of the cover body 156 and to be changeable in position.

A protruding element 157a is formed to protrude from the top of the fixing element 157. The protruding element 157a is coupled to a protruding element coupling opening 175b formed to pass through a center of a lower connection bar 175 of the driving frame 170 to be described later. When the fixing element 157 is turned to protrude, the protruding element 157a of the fixing element 157 is inserted into the protruding element coupling opening 175b of the lower connection bar 175, to maintain a fixing state between the driving frame 170 and the main body frame 150 so that a user is unable to pivot the driving frame 170 forward or backward, thereby preventing an accident when a child, an unskilled person or the like uses the quick board 100 according to the present invention.

The board 140 is provided as a unit for a user to ride on the quick board 100. The board 140 is fixed in the middle part of the main body frame 150, that is, on the top of the body horizontally extending from the rear of the front wheel cover part 151.

A unit for fixing the board 140 may use a well-known connection unit, such as a bolt or the like. No description of the detailed coupling structure will be presented.

As illustrated in the drawings, the driving frame 170 is to drive the front wheel 120 in one direction, that is, to move the quick board 100 forward. The front wheel 120 operatively connected to the driving frame 170 is driven depending on a pivot angle of the driving frame 170.

To this end, the ratchet gear part 160 to be operatively connected to the driving frame 170 contacts with the as described above disk-type plate 152a of the front wheel cover part 151 and is operatively connected to the spline shaft 121 of the front wheel 120.

That is, to rotate the ratchet gear part 160 coupled to the gear-wheels 121a positioned at opposite ends of the spline shaft 121 of the front wheel 130 in either one side so that the front wheel 120 is moved forward in one direction, the driving frame 170 is spaced apart at the opposite sides of the front wheel 120 and is operatively connected to the handle part 110 and the outer circumferential surface of the ratchet gear part 160.

Accordingly, when a user pivots the driving frame 170 forward and backward to pivot the front wheel 130 in a desired direction, the ratchet gear part 160 connected to the guide frame 174 positioned at a lower side of the driving frame 170 is pivoted. Then, since the center of the ratchet gear part 160 is coupled by the gear-wheels 121a at the opposite ends of the spline shaft 121 of the front wheel 120, the one-way clutch bearing 161 of the ratchet gear part 160 is pivoted according to the pivot of the driving frame 170, to rotate the front wheel 120 operatively connected to the driving frame 170 so as to be driven forward.

The ratchet gear part 160 is to transmit the rotation power by being coupled to the gear-wheel in one direction. Generally, the ratchet gear part 160 may apply the one-way clutch bearing as well-known.

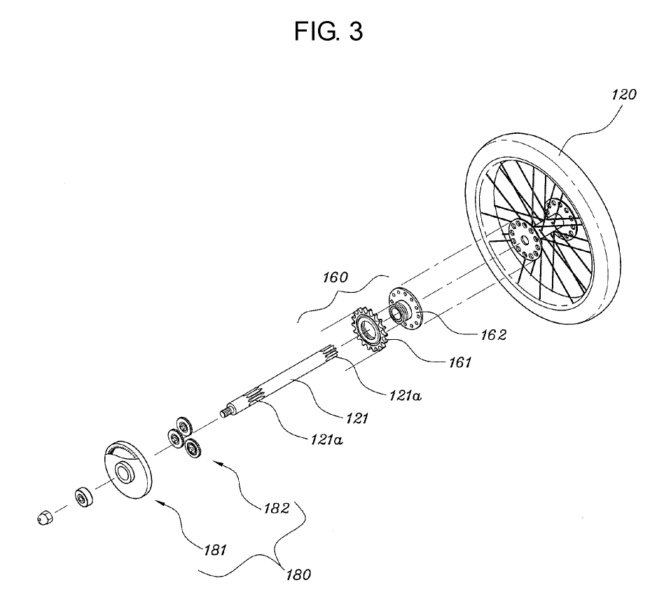

As illustrated in FIG. 3, the planet gear part 180 is positioned at a side of the ratchet gear part 160. The planet gear part 180 uses a planet gear part which is one of the components of the invention disclosed in Korean Patent Registration No. 642140 of the present applicant.

The planet gear part 180 includes three spur gears 182 operatively connected to the gear-wheels 121a of the spline shaft 121, and a planet carrier 181 connected to an outer circumferential surface of each spur gear 182 by a gear-wheel. The planet gear part 180 is provided to be operatively connected to a disk plate 174a, which is integrally connected to either one side end of the guide frame 174 so that the planet gear part 180 is rotated in the same direction by the pivot of the guide frame 174 operated by the pivot of the handle part 110. The spline shaft 121 connected to the spur gears 182 of the planet gear part 180 by the gear-wheels is rotated in a reverse direction to the direction in which the planet gear part 180 is rotated, so that the forward driving power of rotating the front wheel 120 is obtained from an opposite moving direction of the handle part 110.

On the contrary, when the handle part 110 is pivoted in (the other) outward direction, the planet gear part 180 is also rotated in the same direction (as the handle part 110) by the above-described acting relations. Since the planet gear part 180 rotating direction is same as the front wheel 120 driving (forward) direction, the ratchet gear part 160 operatively connected to the planet gear part 180 runs idle by the one-way clutch bearing 161 so that the power is not transmitted to the reverse driving direction of the front wheel 120 and only a handle, that is, the handle part 110 and the driving frame 170 change their positions forward from the front wheel 120.

When a user repeatedly pulls the handle part toward the user's body, the front wheel 120 obtains the forward driving power by the above-described acting relations and repeats a series of process of moving the quick board 100 forward.

In a modified exemplary embodiment of the present invention, when the direction of the one-way clutch bearing 161 in the ratchet gear part 160 is changed, the forward driving power of the front wheel 120 is obtained by pushing the handle part 110 forward. Since such a selection is merely the application of the present invention to be sufficiently predicted, it is obviously within the scope of the present invention.

A structure of the driving frame 170 to have the aforementioned acting relations will be described. The handle part 110 is positioned at a top part of the driving frame 170. An upper connection bar 172 includes a center frame body 171 facing the middle of the handle part 110 fixed on a top surface of the upper connection bar 172, and coupling openings 172a formed at opposite ends of the upper connection bar 172. An up/down lift frame 173 is formed to be connected to the coupling openings 172a.

The guide frame 174 receives or extends the up/down lift frame 173 through guiding the up/down lift frame 173 to be adjusted in length. The guide frames 174 are spaced apart from each other on at opposite side surfaces of the front wheel 120. A lower connection bar 174 is positioned at an upper part of the guide frame 174 and includes coupling openings 175a respectively bored at its opposite side ends, to maintain the guide frames 174 to be spaced apart from each other.

As described above, the upper part of the guide frame 174 is inserted into the coupling openings 175a. The up/down lift frame 173 is inserted to be fixed inside the guide frame 174 insert-protruded from the coupling openings 175a.

To fix the position of the up/down lift frame 173 after it is drawn and received, preferably, a position fixing element 176 may be formed on the upper outer circumferential surface of the guide frame 174.

The position fixing element 176 may be carried out by using a generally used structure.

Close to a lower end of the guide frame 174 is formed of the disk-type plates 152a positioned at the ends of the first branch frame 152 of the main body frame 150 and the ratchet gear part 160 positioned at either side of the disk-type plate 152a or the like is covered by using a side cover body 177.

As illustrated in FIG. 3, the ratchet gear part 160 includes a connection flange 162 to be connected to one side of the front wheel 120, the one-way clutch bearing 161 positioned outside the connection flange 162, and a cover 163 for covering the one-way clutch bearing 161. The outer circumferential surface of the cover 163 is operatively connected to the end of the guide frame 174 of the driving frame 170. Accordingly, when a user pivots the driving frame 170 forward using the handle part 110, the spline shaft 121 is run idle without pivot by the one-way clutch bearing 161. When a user pulls the handle part 110, the rotation power is transmitted to the spline shaft 121 at the same rotation ratio by the gear-wheel connection of the one-way clutch bearing 161 and the spline shaft 121 and obtains the forward transfer power so that the front wheel 120 is driven in the forward direction in which the quick board 100 advances.

Therefore, a user provides the forward power to the quick board 110 by repeating the above-described actions and enjoys the quick board 100.

As described above, since it may cause an accident and may not obtain the optimal pivot power when the driving frame 170 is excessively pivoted in the direction to the front wheel 120, a stopper 152b controls the pivot angle of the driving frame 170.

Further, when a user is a child, an unskilled person or the like, it may be difficult to pivot the driving frame 170 forward or backward while riding on the quick board 100. In this case, if the protruding element 157a of a driving frame fixing part 158 positioned in the front end of the main body frame 150, that is, at the upper end of the front wheel cover part 151, is inserted into a protruding element coupling opening 175b in the middle of the lower connection bar 175 provided to maintain the guide frames 174 to be spaced apart from each other. Then, no forward transfer power is obtained through pivoting the handle part 110 and the driving frame 170 forward or backward. Therefore, like a general quick board, a user obtains the forward transfer power by sliding on the ground by the user's foot, to safely enjoy the quick board 100.

### SECOND EXEMPLARY EMBODIMENT

The quick board according to the first exemplary embodiment obtains the forward driving power of the front wheel by the planet gear part when the handle part is pivoted. A quick board 100 according to the second exemplary embodiment of the present invention has the same structure of the quick board according to the first exemplary embodiment, except that a chain unit is used to obtain the driving power of the front wheel, without the planet gear part.

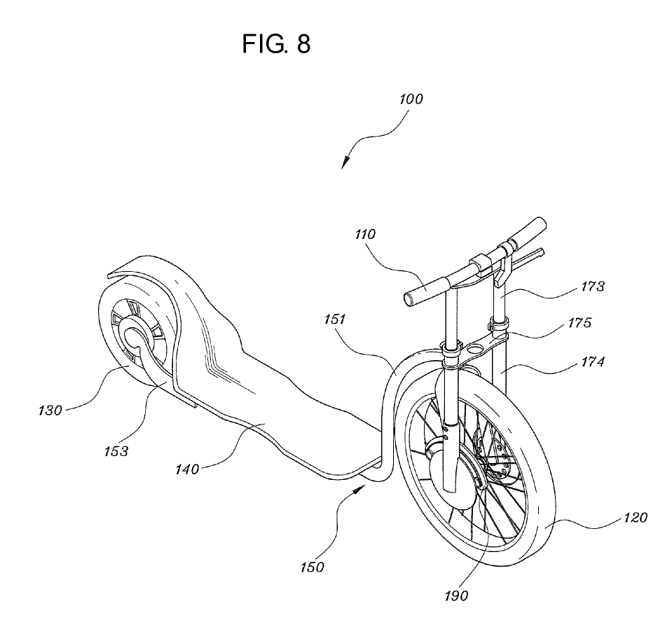

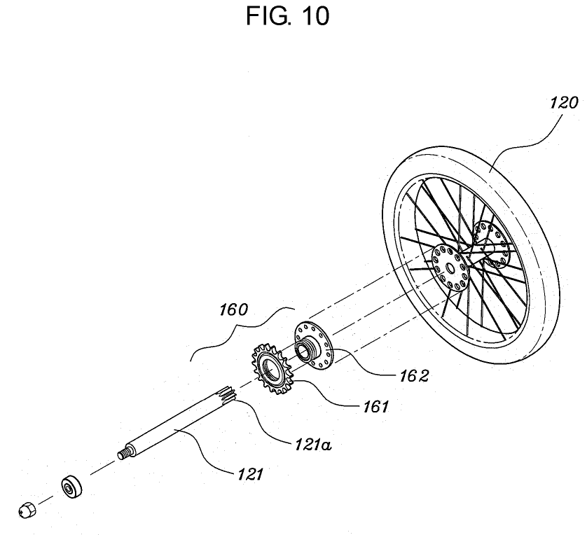

As illustrated in FIGS. 8 through 13, in the quick board 100 according to the second exemplary embodiment, front and rear wheels 120 and 130 are connected by a main body frame 150, a driving frame 170 connected to a handle part 110 is connected to the opposite sides of the front wheel 120, and a ratchet gear part 160 is connected to either one side of the front wheel 120 so as to be pivotable to drive the front wheel 120 in the forward direction. When a user pivots the handle part 110 forward or backward, the driving frame 170 operatively connected to the handle part 110 rotates the ratchet gear part 160, so that the quick board 100 is moved forward as the front wheel 120 is driven forward.

As described above, the basic structure of a quick board 100 according to the second exemplary embodiment is same as that of the quick board 100 of the first exemplary embodiment. The quick board 100 according to the second exemplary embodiment comprises: a main body frame 150, a front wheel 120 and a rear wheel 130, a board 140 stably received and fixed on to the main body frame 150, a driving frame 170 for driving the front wheel 120, and a handle part 110 for controlling the driving frame 170 to be pivoted forward or backward.

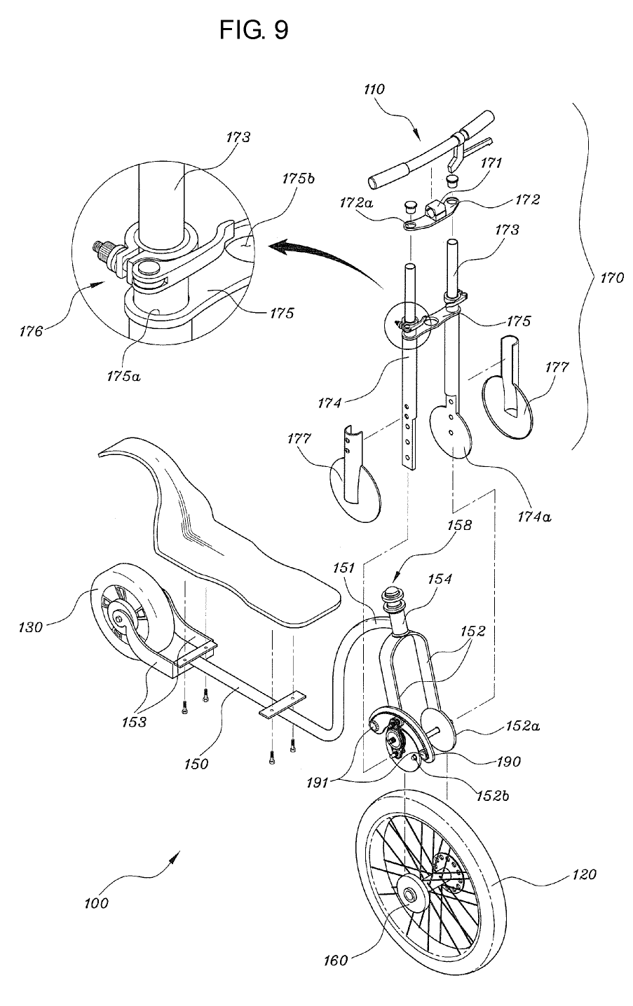

As illustrated in FIG. 9, the structure of the main body frame 150 is same as that described with reference to the first exemplary embodiment.

A first branch frame 152 is configured, irrelevantly to the driving of the front wheel 120. To transmit the driving power to a spline shaft 121 of the front wheel 120, a pivot power by the handle part 110 controlled by a user enables to drive the quick board 100 forward, like the first exemplary embodiment.

The structure of the driving frame 170 is also same as that of the first exemplary embodiment. Specifically, in the second exemplary embodiment of the present invention, when a user pivots the driving frame 170 forward or backward by using the handle part 110 to provide the driving power to the front wheel 120, the pivot power drives the front wheel 120 through a power transmission unit formed by the gear-wheel coupled to gears, as illustrated in the attached drawings.

To this end, a bracket 190 in a flat shape is horizontally fixed to the either outer surface side of the first branch frame 152. Gear-wheels 191 are each positioned at opposite side ends of the bracket 190. A guide chain 192 is provided to connect the gear-wheels 191 formed at the opposite side ends of the bracket 190.

Each gear-wheel 191 is fixed by a shaft so as not to be rotated. The guide chain 192 forms a caterpillar trace and is not rotated, thereby maintaining a fixed situation.

As illustrated in the drawings, a driving gear 200 connected to the guide chain 192 by the gear-wheels is provided to a guide frame 174 which is a component of the driving frame 170.

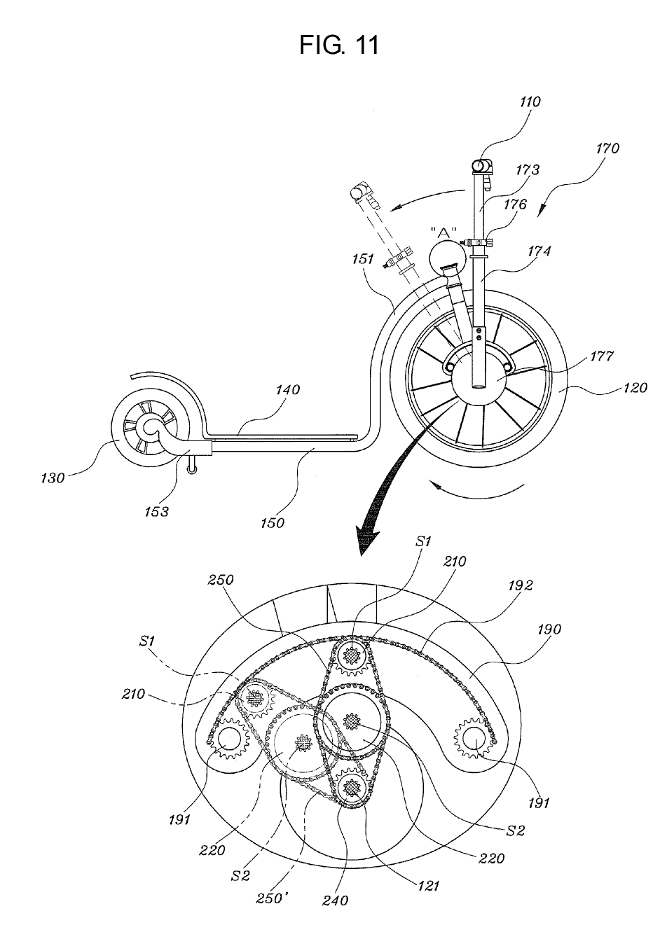

In FIG. 11, reference mark “S1” is called a first shaft.

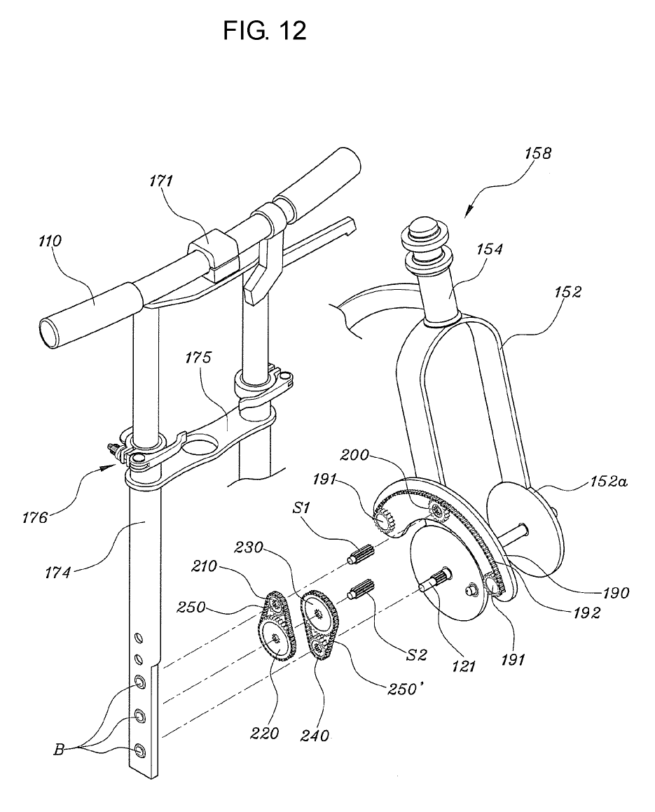

As illustrated in FIG. 11 and FIG. 12, the driving gear 200 mounted on the first shaft S1 is connected to the guide chain 192 by the gear-wheels. As a user pivots the handle part 110 forward or backward, the driving gear 200 operatively connected to the first shaft S1 is pivoted, along the guide chain 192.

Further, a first coaxial gear 210 having the same rotation ratio as that of the driving gear 200 is provided on the first shaft S1 where the driving gear 200 is provided.

The first coaxial gear 210 and the driving gear 200 have the same rotation ratio, and it is preferable to form the diameter of the first coaxial gear 210 same as that of the driving gear 200.

Further, as illustrated in FIG. 11 and FIG. 12, to transfer the driving power of the first coaxial gear 210, a first driven gear 220 connected by a chain 250 is positioned to be rotated directly downward from the first coaxial gear 210, that is, about a second shaft S2 at a lower end of the guide frame 174.

Then, the diameter of the first driven gear 220 is to be greater than that of the first coaxial gear 210, to transfer the maximum driving power to the front wheel 120.

Further, a second coaxial gear 230 having the same diameter as the first driven gear 220 is mounted on the second shaft S2 where the first driven gear 220 is mounted, and a second driven gear 240 mounted on the spline shaft 121 is connected to the second coaxial gear 230 by a chain 250.

The end of the spline shaft 121 is connected to a bearing B provided in the guide frame 174, to connect the driving frame 170 to the spline shaft 121 so as to be supported.

Accordingly, to drive the front wheel 120 in the second exemplary embodiment of the present invention, a user pivots the handle part 110 forward or backward to obtain the forward driving power. When the handle part 110 is pivoted forward or backward, the driving frame 170 is pivoted in the same direction. Then, the driving gear 200 provided at the lower end part of the driving frame 170 is pivoted, along the guide chain 192 connected to the gear-wheels 191 of the bracket 190 fixedly positioned at the side of the first branch frame 152.

When the rotation power is transmitted to the first shaft S1 by the driving gear 200 pivoting along the guide chain 192, the first coaxial gear 210 mounted on the first shaft S1 is rotated with the same rotation ratio, thereby rotating the first driven gear 220 connected directly downward to the first coaxial gear 210 by the chain 250 or the like.

The diameter of the first driven gear 220 is greater than that of the first coaxial gear 210.

Further, the second coaxial gear 230 mounted on the same second shaft S2 on which the first driven gear 220 is mounted has the same diameter as the first driven gear 220 and is rotated with the same rotation ratio, thereby rotating the second driven gear 240 mounted on the spline shaft 121 directly downward to the second coaxial gear 230. Then, the rotation power rotates the spline shaft 121, enabling the driving of the front wheel 120.

The driving power is transferred to the front wheel 120 by the pivot of the handle part 110. Then, only when the handle part 110 is pivoted in any one direction as selected, i.e., in the front or rear, the driving power is to be transferred to the front wheel 120.

To this end, in the present invention, a one-way clutch bearing 161 of the ratchet gear part 160 has the aforementioned function, and the acting relations thereof are same as those described with reference to the first exemplary embodiment.

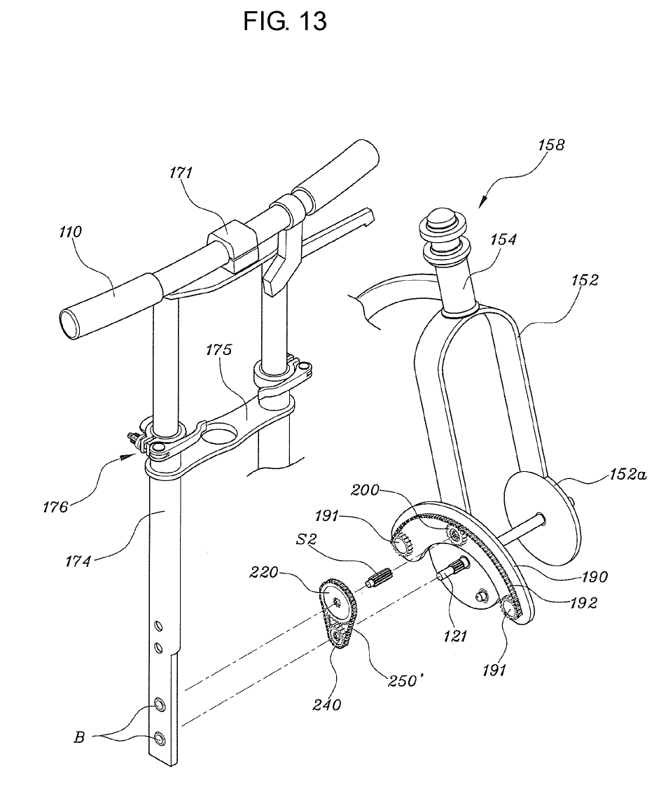

As illustrated in FIG. 13, the same driving power can be transferred by using the second shaft S2 only, without the first shaft S1. For example, the bracket 190 is fixedly positioned toward a far lower end of the first branch frame 152 and the driving gear 200 having a small diameter is positioned on the second shaft S2. The driving gear 200 is connected to the guide chain 192 connected to the gear-wheels 191 of the bracket 190, using the gear-wheels. The first driven gear 220 having a big diameter is mounted on the same shaft on which the driving gear 200 is positioned. The second driven gear 240 having a small diameter, which is connected to the first driven gear 220 by the chain 250, is mounted on the spline shaft 121. When a user pivots the handle part 110, the pivot power drives the front wheel 120 through the gear-wheel motion of each gear.

In the second exemplary embodiment of the present invention, the power transmission unit is illustrated and described by using the gears, chains and the like. However, the present invention does not limit the power transmission unit to the gears, chains and the like.

For example, the gear-wheels 191 of the bracket 190 may be replaced by guide rollers. In this case, the first and second coaxial rollers and the first and second driven rollers replaced by the guide rollers may be secured by a belt or the like. A driving roller in contact with the belt, a first coaxial roller connected to the driving roller by a first shaft, a first driven roller connected to the first coaxial roller by a belt, a second coaxial roller mounted to the first driven roller by a second shaft, and a second driven roller connected to the second coaxial roller by a belt or the like and mounted on the spline shaft 121, thereby obtaining the same driving power. It is obvious that these alternative arrangements are within the scope of the present invention.

In the quick board 100 according to the second exemplary embodiment of the present invention, when the driving frame 170 is pivoted by using the handle part 110, the driving power for the direction in which the quick board 100 advances is transmitted to the front wheel 120 operatively connected to the driving frame 170. The structure of transmitting the driving power to drive the front wheel 120 forward will be described below:

That is, to rotate the ratchet gear part 160 coupled to the gear-wheels 121a positioned at the opposite ends of the spline shaft 121 on either one side surface of the front wheel 130 so that the front wheel 120 is moved forward in one direction, the driving frame 170 spaced apart at the opposite sides of the front wheel 120 is operatively connected to the handle part 110 and the outer circumferential surface of the ratchet gear part 160.

Accordingly, when a user pivots the driving frame 170 forward or backward to pivot the front wheel 130 in a desired direction, the ratchet gear part 160 connected to the guide frame 174 positioned at a lower part of the driving frame 170 is pivoted. Then, since at the center of the front wheel 120, the ratchet gear part 160 is coupled to the gear-wheels 121a at the opposite ends of the spline shaft 121, the one-way clutch bearing 161 of the ratchet gear part 160 is pivoted according to the pivot of the driving frame 170 and rotates the front wheel 120 forward which is operatively connected to the driving frame 170.

The ratchet gear part 160 for transmitting the rotation power by being coupled to the gear-wheel in one direction uses the one-way clutch bearing as described with reference to the first exemplary embodiment and illustrated with reference to the relevant drawings.

That is, in the second exemplary embodiment like the first exemplary embodiment, when the direction of the one-way clutch bearing 161 in the ratchet gear part 160 is changed, the forward driving power of the front wheel 120 is obtained by pushing the handle part 110 forward.

In the quick board with the handle to operate the driving power of the front wheel according to the present invention, only the front wheel is driven and the effect of the whole body exercise is increased while removing the complicated configuration in appearance by minimizing the components of the quick board.

Furthermore, when the quick board according to the present invention is used by a child who has difficulties in pivoting forward or backward the driving frame operatively connected to the handle part to drive the front wheel or the like, the front wheel cover part of the main body frame and the driving frame are structured to be fixed so that the child or the like can enjoy the quick board in a stable state.

Furthermore, unlike a quick board which is operated by a user's foot sliding on the ground, the front wheel of the quick board according to the present invention is operated by pivoting the driving frame operatively connected to the handle part. Therefore, the present invention is expected to have the effects of improving the exercise of the upper part of the body as well as the exercise for the muscular strength of a user.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A quick board with a handle to operate a driving power of a front wheel which includes a handle part, a board, and, front and rear wheels, comprising:
a main body frame supportedly connected to opposite sides of the front wheel by a first branch frame divided from an upper end of a front wheel cover part in a rod shape covering from a rear side of the front wheel to a top part of the front wheel, and the main body frame supportedly connected to opposite sides of the rear wheel by a second branch frame divided from a front side of the rear wheel in a rod shape and horizontally extended straight from a lower end of the front wheel cover part;
a driving frame including a ratchet gear part and a planet gear part in either side of the front wheel to forward drive the front wheel in one direction and to rotate the ratchet gear part and the planet gear part, wherein the ratchet gear part includes a one-way clutch bearing to be coupled to gear-wheels positioned at opposite ends of a spline shaft of the front wheel and the planet gear part is provided to contact with a side of the ratchet gear part, and the driving frame spaced apart at the opposite sides of the front wheel is operatively connected to the handle part and the outer circumferential surface of the ratchet gear part; and
a board stably received and connected to the top surface side of the main body frame.

2. The quick board according to claim 1, wherein the first branch frame includes disk-type plates at its both ends, the ratchet gear part is positioned on either inside surface of the disk-type plate, and a stopper is positioned on either outside surface of the disk-type plate.

3. The quick board according to claim 1, wherein the driving frame includes a center frame body, an upper connection bar, an up/down lift frame, a guide frame, a lower connection bar and a disk plate, wherein
the handle part is positioned on a top part of the driving frame,
the central frame body is positioned to face to a middle of the handle part and is fixed to a top surface of the upper connection bar,
the upper connection bar includes coupling openings at its opposite side ends,
the up/down lift frame is connected to each coupling opening,
the guide frame for receiving or receiving and extending the up/down lift frame guides the up/down lift frame so as to be adjusted in length and is positioned to be spaced apart at each side of the front wheel,
the planet gear part is operatively provided to the disk plate integrally connected to the end at either side of the guide frame, and
the lower connection bar includes coupling openings bored at its opposite side ends at upper part of the guide frame to maintain a spacing of the guide frame.

4. The quick board according to claim 3, wherein the lower connection bar forms a protruding element coupling opening at its middle.

5. The quick board according to claim 1, wherein the main body frame includes:
a cylindrical member, a coupling element, a bearing, a cover body, a fixing element and a protruding element, wherein
the bearing is inserted into the inner circumferential surface side on the top of the cylindrical member at the contact point where a upper end of the front wheel cover part of the main body frame contacts with the first branch frame extending downward from the upper end of the front wheel cover part,
the coupling element is formed to protrude from the inner circumferential surface of the bearing and to be integral with the cylindrical member and has the outer circumferential surface forming a screw,
the cover body is hollow to be screw-coupled to the coupling element and has the inner circumferential surface forming a female screw, and
the fixing element includes the protruding element protruding on an upper side and is screw-coupled to the female screw formed on the inner circumferential surface of the cover body to be changeable in position.

6. A quick board with a handle to operate a driving power of a front wheel which includes front and rear wheels provided in front and rear of a main body frame, a board stably received and fixed to a top part of the main body frame and a handle part, comprising:
a main body frame supportedly connected to opposite sides of the front wheel by a first branch frame divided from an upper end of a front wheel cover part in a rod shape covering from a rear side of the front wheel to a top part of the front wheel, and the main body frame supportedly connected to opposite sides of the rear wheel by a second branch frame divided from a front side of the rear wheel in a rod shape horizontally extended straight from a lower end of the front wheel cover part;
a driving frame including a ratchet gear part in either one side of the front wheel to forward drive the front wheel in one direction and to rotate the ratchet gear part, wherein the ratchet gear part includes a one-way clutch bearing to be coupled to gear-wheels positioned at opposite ends of a spline shaft of the front wheel, and the driving frame spaced apart at the opposite sides of the front wheel is operatively connected to the handle part and the outer circumferential surface of the ratchet gear part; and
a bracket fixed to a side of the first branch frame, gear-wheels each positioned at the left and right sides of the bracket, a guide chain connecting the gear-wheels, a guide frame extended downward at a lower end side of the driving frame, a driving gear coupled to the guide chain by the gear-wheels, a first coaxial gear which is connected to the driving gear by a shaft (a first shaft) and connected to a first driven gear by a chain, a second coaxial gear which is connected to a second driven gear by a chain and connected to the first driven gear by another shaft (a second shaft) so as to be rotated in the guide frame, wherein the second driven gear is operatively connected to the spline shaft so that when the handle part is pivoted, the rotation power of the driving gear rotates the second driven gear, to drive the front wheel through the spline shaft.

7. The quick board according to claim 6, wherein the diameter of the first coaxial gear is same as that of the driving gear.

8. The quick board according to claim 6, wherein each of the gear-wheels fixed at the opposite ends of the bracket is fixed by a shaft, and the guide chain forms a caterpillar trace and maintains a fixed situation without rotation.

9. The quick board according to claim 6, wherein diameter of the first driven gear is greater than that of the first coaxial gear.

10. The quick board according to claim 6, wherein diameter of the second coaxial gear mounted on the second shaft on which the first driven gear is mounted is same as that of the first driven gear, and diameter of the second driven gear mounted on the spline shaft is smaller than that of the second coaxial gear.

11. The quick board according to claim 6, wherein the gear-wheels of the bracket are substituted by:
guide rollers,
a belt is used to fix a space between the guide rollers, and
a driving roller contacting with the belt, a first coaxial roller connected with the driving roller by a shaft, a first driven roller connected to the first coaxial roller by a belt at a straightly downward position, a second coaxial roller connected with the first driven roller by another shaft, and a second driven roller connected to the second coaxial roller by a belt and mounted on the spline shaft are used for substitution.
